(19) United States
(12) Patent Application Publication
(10) Pub. No.: US 2014/0022319 A1
(43) Pub. Date: Jan. 23, 2014

(54) INK DELIVERY SYSTEM FOR AN IMAGING DEVICE

(71) Applicants: Glenn David Batchelor, Fairport, NY (US); Ali R. Dergham, Fairport, NY (US); Frank B. Tamarez Gomez, Rochester, NY (US); Mark Anthony Adiletta, Fairport, NY (US)

(72) Inventors: Glenn David Batchelor, Fairport, NY (US); Ali R. Dergham, Fairport, NY (US); Frank B. Tamarez Gomez, Rochester, NY (US); Mark Anthony Adiletta, Fairport, NY (US)

(73) Assignee: XEROX CORPORATION, Norwalk, CT (US)

(21) Appl. No.: 13/550,614

(22) Filed: Jul. 17, 2012

(51) Int. Cl. B41J 2/175

(52) U.S. Cl. 347/88; 347/85

(57) ABSTRACT

An ink delivery system for transporting thermally treated ink from different ink reservoirs to multiple print he ads of an imaging device includes a rigid injector assembly, and multiple pliable tubes attached to the injector assembly. The injector assembly includes two T-shaped members made of a conducting material, positioned one a top the of her. Each of the two members has grooves provided within it. The grooves within one of the members align with the grooves within the other member, to create channels, which carry ink to the pliable tubes. The pliable tubes are made of a flexible material, such that the lower end of each pliable tube is freely movable with respect to the injector assembly. A heating mechanism surrounds the injector assembly and the pliable tube, and remains in thermal communication with the system, to keep the ink in molten state all through the transportation path within the ink delivery system.

### TECHNICAL FIELD

Embodiments of the present disclosure generally relate to fluid transportation systems, and, more specifically, to systems for transporting ink to multiple print heads of an imaging device.

### BACKGROUND

Fluid transport systems are commonly used to transport different fluids from a supply source to a receptacle. Many fluids require thermal treatment before or during transportation through the fluid transport systems. For example, many imaging devices, including printers, scanners and photocopiers, etc., generally include an ink delivery system that transports thermally treated ink to the different print heads of these devices. Specifically, the heated ink delivery system includes a number of ink reservoirs for supplying different colored ink fluids, and generally, an assembly for transporting the ink from the ink reservoirs to the print heads.

Maintaining thermal uniformity in the ink supplied to the print head, and continuously keeping the ink in molten state and within a desired temperature range during transportation, presents a challenge in many imaging devices. Specifically, depending on the shape and dimensions of the assembly transporting the ink from the reservoirs to the print heads, the ink often solidifies in the middle of transportation path. This situation results in accumulation of solidified ink within the transportion assembly and obstructs its functionality. Further, in many conventional imaging devices, sometimes the ink-supplying reservoirs are remotely located with respect to the print head, and the transportation path traversed by the ink, before reaching the print head, is substantially long. Moreover, if the ink transportation assembly is not insulated, it allows ambient air to extract heat from the molten ink, and eventually, the ink solidifies.

Conventionally, heating mechanisms are deployed and coupled to the ink transportation mechanisms within imaging devices for continuously supplying heat to the transported ink. However, many such mechanisms are only partially effective in continuously maintaining thermal uniformity within the supplied ink. At times, the design layout of the heating mechanisms and the shape complexity of the transportation assembly may lead to development of variations in the temperature of the supplied ink, at different locations in the transportation path.

Among the other conventional attempts to transport molten ink to the print heads smoothly, one such mechanism uses multiple flexible conduits, which receive ink from different ink reservoirs, and are connected to the print heads. The conduits are placed on a heating plate, which supplies heat to maintain the ink in a molten state within the conduits. However, the conduits may dislocate due to movement of the print heads over the printing surface. The dislocation of the conduits detaches certain portions of the conduits from the heating plate, resulting in development of cold spots in those portions.

Therefore, considering the problems mentioned above, there exists a need for a mechanism for maintaining thermal uniformity in the ink supplied from different ink reservoirs to the print heads of an imaging device. Specifically, a need exists for a mechanism that can maintain the supplied ink in molten form, all through the transportation path that leads to the print head.

### SUMMARY

The present disclosure provides an ink delivery system for transporting ink from one or more ink reservoirs to multiple print heads of an imaging device. The imaging device can be a printing machine, a photocopier, or a scanner, etc. The system maintains thermal uniformity in the transported ink, and keeps the ink in a substantially molten state all through the transportation path.

In one aspect, the present disclosure provides a system for transporting thermally treated ink from different ink reservoirs to multiple print heads of an imaging device. The system includes a rigid injector assembly, and multiple pliable tubes attached to the injector assembly. The injector assembly includes two substantially T-shaped members made of a conducting material. Each of the two members has grooves provided within it. The grooves within one of the members align with the grooves within the other member, to create channels which carry ink to the pliable tubes. Each such channel connects an inlet port and an exit port of the injector assembly. A heating mechanism surrounds the injector assembly, and remains in thermal communication with the ink flowing in the different channels, to keep the ink in molten state within the injector assembly. Further, each exit port of the injector assembly is connected to an upper end of one of the pliable tubes, through a threaded coupling. A lower end of each pliable tube is connected to a print head of the printing device. The pliable tubes are made of a flexible material, such that the lower end of each pliable tube is freely movable with respect to the injector assembly.

### BRIEF DESCRIPTION OF THE DRAWINGS

FIG. 1 is a top view of an ink delivery system, in accordance with the present disclosure.

FIG. 2 illustrates the structure and shape of the pliable tubes as an integral part of the ink delivery system, in accordance with the present disclosure.

FIG. 3 is a front view of an injector assembly, the injector assembly being a part of the ink delivery system of the present disclosure.

FIG. 4 illustrates the shape and structure of a pliable tube shown in FIG. 1, in accordance with an embodiment of the present disclosure.

FIG. 5 shows a disassembled top view of the injector assembly of FIG. 1, in accordance with the present disclosure.

### DETAILED DESCRIPTION

The following detailed description is made with reference to the figures. Preferred embodiments are described to illustrate the disclosure, and not to limit its scope, which is defined by the claims. Those of ordinary skill in the art will recognize a variety of equivalent variations on the description that follows.

### Overview

Ink delivery systems have been used to transport ink from ink reservoirs to multiple print heads in imaging devices, such as printers, scanners, photocopiers, etc. These devices employ different color inks to facilitate color printing. While being transported from the reservoirs to the prints heads, the ink may solidify in certain portions of the transportation path. The solidification of ink obstructs the flow of ink to the print heads of the imaging device. Therefore, the ink is required to be in molten state throughout the transportation process.

Many imaging devices use heating mechanisms to keep the ink in molten form. For example, where the ink delivery systems use different conduits to transport ink from the reservoirs to the print heads, a heating mechanism is used to keep ink flowing within the conduits in a molten state. Heating plates may be attached to these conduits for thermally treating the ink flowing within them. The conduits are flexible, however, and they have a tendency to dislocate, which may produce thermal non-uniformity within the conduits.

The present disclosure presents an effective system for delivering thermally treated ink in an imaging system. The disclosure enables smooth transportation of ink from reservoirs to print heads, and keeps the flowing ink in molten state across the transportation path from the reservoirs to the print heads.

### Exemplary Embodiments

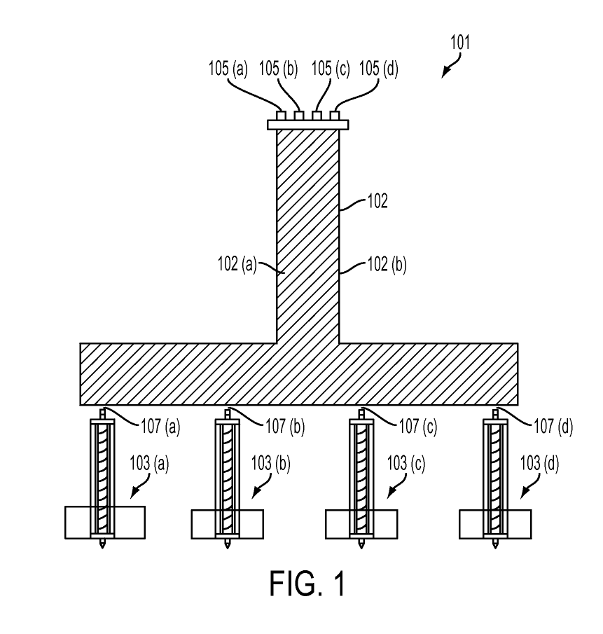

FIG. 1 illustrates a top view of a system for delivering ink to multiple print heads of an imaging device, in accordance with the present disclosure. The imaging device may be a printer, a scanner or a photocopier, etc. As shown, the system 101 includes a rigid injector assembly 102 and multiple pliable tubes 103 (a)-103 (d) attached to the injector assembly 102. The injector assembly 102 includes a first T-shaped member 102 (a), and a second T-shaped member 102 (b) positioned below the first T-shaped member 102 (a). The members 102 (a) and 102 (b) can also be of any other appropriate shape, thus, not limiting the scope of the present disclosure. When positioned one atop the other, the two members substantially align to create a closed structure. Hereinafter, the first and the second T-shaped members will be simply referred to as the ‘first member 102 (a)’ and the ‘second member 102 (b)’, respectively, for simplicity and economy of expression. The two members 102 (a) and 102 (b) are composed of an appropriate conducting material, having a sufficiently high melting point. Preferably, the two members are composed of Aluminum. However, other suitable conducting materials may also be used. The exact dimensions of the injector assembly 102 may vary, depending upon factors, including the space constraints and the size of the imaging device. In a preferred embodiment, the length of the elongate arm of the T-shaped injector assembly 102 is about 25-30 cm. Further, the width of the arm of the injector assembly 102 that is coupled to the pliable tubes 103 (a)-103 (d) is about 150 cm. The internal structure of the two members 102 (a) and 102 (b) will be explained in further detail, below

A set of inlet ports 105 (a)-105 (d) is provided at an appropriate location on an upper end of the injector assembly 102. Similarly, multiple exit ports 107 (a)-107 (d) are disposed at a lower end of the injector assembly 102. Multiple channels disposed within the injector assembly 102, (though not shown herein), extend between the inlets ports 105 (a)-105 (d) and the exit ports 107 (a)-107 (d) of the injector assembly 102. Each such channel facilitates the flow of ink from an inlet port to an exit port. Specifically, for example, one such channel extends between and connects the inlet port 105 (a) to the exit port 107 (a). That channel routes the ink from the inlet port 105 (a) to the exit port 107 (a). The ink, in molten form, enters the injector assembly from the inlet ports 105 (a)-105 (d), flows through the different channels, and exits through the exit ports 107 (a)-107 (d). Eventually, the ink is received into the pliable tubes 103 (a)-103 (d) from the exit ports 107 (a)-107 (d).

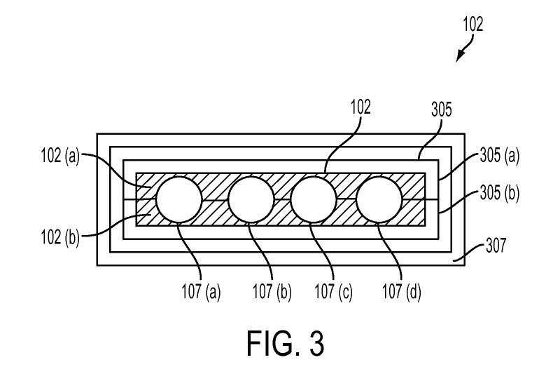

The injector assembly 102 is surrounded by a heating assembly (FIG. 3). The heating assembly substantially encompasses the injector assembly 102, and remains in thermal communication with the different channels within the injector assembly 102. By continuously transferring heat to the ink flowing within the different channels, the heating assembly maintains the ink within a specific temperature range, thus preventing it from solidifying within the channels. In a preferred embodiment, the heating assembly includes two heating strips attached to a top portion and a bottom portion of the injector assembly 102. Specifically, a first heating strip is attached to the first member 102 (a), and a second heating strip is attached to the second member 102 (b).

The two heating strips supply heat to the first member 102 (a) and the second member 102 (b), and since the two members are composed of a conducting material, the supplied heat is easily conducted to the ink flowing in the channels within the injector assembly 102. Any other suitable heating mechanism may also be alternatively used, for transferring heat to the ink flowing within the channels of the injector assembly.

The ink delivery system 101 of the present disclosure is divided into multiple heating zones. Specifically, the injector assembly 102 and each of the pliable tubes 103 (a)-103 (d) are confined within different heating zones. Each heating zone includes a heating element that heats the ink flowing through the system within the zone, and a thermistor that controls the temperature of the ink within the zone. The thermistors in the different heating zones control the heat flowing into the zones, by providing a resistive feedback to a control circuit. The heating element includes an electrical resistance that may be a heater strip or a heater wire, which is connected to a current supplying source. On receiving the current from the current source, the heating element generates heat as the current flows through it. In an embodiment, a Kapton heater may be used as the heating element. Those in the art will understand that a Kapton heater is formed by configuring serpentine resistive heating traces on a non-conductive substrate. The watt density of a Kapton heater can be altered by changing the number of traces present on the substrate. Alternative heating elements, such as a silicone heater strip, may also be used for different temperature requirements in different zones, and to address space and cost limitations. A silicone heater strip is an assembly of heating wires encased in silicone.

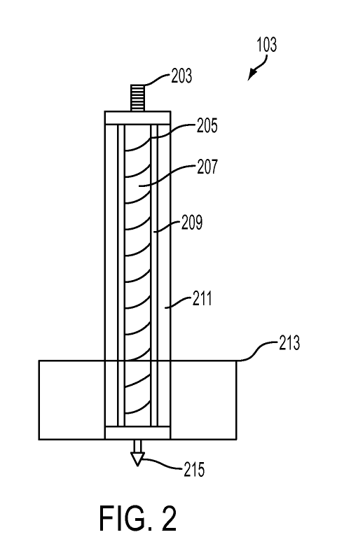

FIG. 2 illustrates the structure and shape of the pliable tubes 103. As shown, the pliable tube 103 includes an upper threaded portion 203, which facilitates engagement of the pliable tube 103 with the injector assembly 102. Specifically, a threaded portion is present within each of the exit ports 107 (a)-107 (d) (shown in FIG. 1) of the injector assembly 102. The upper threaded portion 203 engages with a threaded portion within one of the exit ports of the injector assembly. This structure facilitates fluid communication between the injector assembly 102 and the pliable tube 103. However, other appropriate means can also be used to attach the pliable tubes 103 to the different exit ports of the injector assembly. Further, a lower portion of the pliable tube 103 is attached to a print head 215 of the imaging device. The print head 215 is made of a piezoelectric material (which changes shape in response to an applied voltage). Any change in the shape of the piezoelectric material generates a pressure pulse within the print head. Such generated pressure pulses impel droplets of ink through microscopic print head orifices, onto an imaging surface.

The pliable tube 103 is made of flexible material, which facilitates the movement of its lower portion with respect to the injector assembly 102, as the print head moves over the imaging surface. Further, the pliable tube 103 includes a conduit 207, which receives ink from one of the exit ports 107 (a)-107(d) (shown in FIG. 1) and delivers it to the print head 215. The conduit 207 is surrounded by a heating assembly 205, which remains in thermal communication with the ink flowing within the conduit 207. Specifically, the heating assembly 205 transfers heat to the ink within the conduit 207, to maintain the ink in molten form. The heating assembly 205 includes a heating element connected to a power supply source, through an adapter fitting 213. The heating element may be a heating strip or a heating wire, having an electrical resistance. In this manner, the heating assembly 205 prevents the ink from solidifying within the pliable tube 103. A braided shielding 209 surrounds the heating assembly 205. The braided shielding protects the sensitive electronic circuit within the heating assembly 205. Further, the braided shielding 209 is covered by an insulation layer 211, which prevents loss of thermal energy from the pliable tube 103.

Each pliable tube 103 has a length above a certain value, to facilitate smooth movement of the lower end of the pliable tube 103 with respect to the print head. The length of the pliable tubes 103 may vary, depending on the size and dimensions of the injector assembly, to facilitate flexible movement of the lower end of the pliable tubes 103 over the printing interface. In a preferred embodiment, the length of the pliable tube is approximately 15 cm. Further, the minimum length of the pliable tube 103, may vary in different embodiments, and is not intended to limit the scope of the present disclosure.

FIG. 3 illustrates a front view of the injector assembly 102 of FIG. 1, showing the exit ports 107 (a)-107 (d), a heating assembly 305, and an insulation layer 307 surrounding the heating assembly 305. The exit ports 107 (a)-107 (d) are provided at the outlets of the different channels (not shown here) present within the injector assembly 102. Each of these exit ports 107 (a)-107(d) has an inner threaded portion. As noted above, the inner threaded portion within each exit port engages the upper threaded portion of one of the pliable tubes. The exit ports 107 (a)-107 (d) are configured to deliver molten ink to the pliable tubes. Each exit port 107 (a)-107 (d) has a circular aperture, to engage with the circular cross-section of the upper end of the pliable tube. Specifically, the exit ports 107 (a)-107 (d) have a cross-section slightly larger than the cross-section of the upper portion of the pliable tubes, enabling them to receive the pliable tubes.

Further, the injector assembly 102 is surrounded by a heating assembly 305, which consists of two elements. Though shown as a consolidated body, the heating assembly 305 consists of a first heating element 305 (a), attached to the first member 102 (a), and a second heating element 305 (b) attached to the second member 102 (b) of the injector assembly 102. As shown, the heating assembly 305 substantially encompasses the injector assembly 102 and is in the form of a resistive heater strip or a heater wire that generates heat in response to an electrical current flowing through it. A power supply source is connected to the heating assembly 305, which supplies current to the heating elements of the heating assembly 305. The insulation layer 307 surrounds the heating assembly 305, to minimize heat losses from the injector assembly 102. Those in the art will understand that any conventionally known insulating material can be used to form the insulation layer 307.

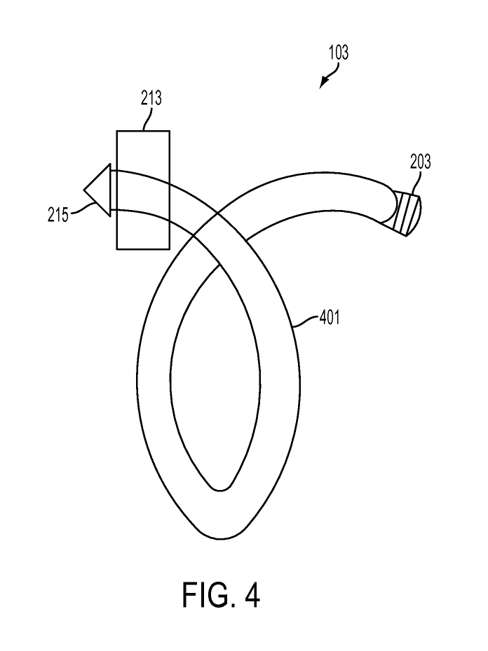

In an embodiment, as shown in FIG. 4, the pliable tubes of the ink delivery system are curl shaped. The curl shape enables the pliable tube 103 to move vertically with respect to the imaging surface. This movement is required during transitions of the print head from one location on the printing surface to another. The curled pliable tube 103, as shown, can be optionally used in certain embodiments, depending upon factors like, the existing flexibility, the total diameter of the pliable tube 103 and space restrictions. Here, the internal components, and their means of attachment, are similar to the structures described earlier. Specifically, the curled pliable tube 103 includes an upper threaded portion 203 which engages a threaded slot within one of the exit ports 107 (a)-107 (b) of the injector assembly 102 (shown earlier in FIG. 1). As noted, the lower portion of the curled pliable tube 103 is attached to the print head 215 and is flexible to move with respect to the injector assembly 102. This facilitates the movement of the print head 215 in multiple directions, to facilitate printing on the imaging surface. Specifically, as the print head 215 moves over the imaging surface, after printing a specific word, a phrase or a complete line, it needs to lift up, to move to the next word, phrase or the next line. The curled shape of the tube 103 easily facilitates and supports this vertical movement of the print head 215, with respect to the imaging surface.

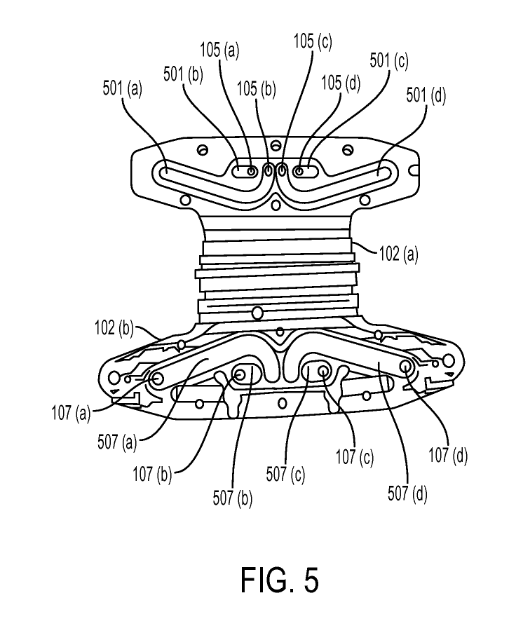

FIG. 5 illustrates a disassembled top view of the injector assembly 102 of FIG. 1, showing the internal structure of the first member 102 (a), and the second member 102 (b). The two members 102 (a) and 102 (b) are composed of an appropriate conducting material, to facilitate transfer of heat to the ink flowing in the different channels of the injector assembly 102, and to maintain thermal uniformity within the flowing ink. In a preferred embodiment, the composing material is aluminum. Aluminum, having a melting point at about 600° C., maintains the ink at the required temperature of about 115° C. However, other conducting materials, having a sufficiently high melting point, to achieve this purpose, can also be used as an alternative. Though shown as being T-shaped, the two members 102 (a) and 102 (b) can also be of a different shape, depending on certain factors, including space constraints.

Further, each of the first member 102 (a) and the second member 102 (b) has multiple grooves provided within it. Specifically, as shown, a multiple grooves 501 (a)-501 (d) are provided within the first member 102 (a), and similarly, multiple grooves 507 (a)-507 (d) are provided within the second member 102 (d). Multiple inlet ports 105 (a)-105 (d) are provided over a top portion of the first member 102 (a), to receive ink from different ink reservoirs connected to the injector assembly 102 (though not shown). Specifically, each inlet port 105 is coupled to a reservoir containing ink of a specific color. Similarly, a number of exit ports 107 (a)-107 (d), 505 (a)-505 (d) are provided over a bottom portion of the second member 102 (b), to deliver ink to the pliable tubes 103 (a)-103 (d) (shown in FIG. 1), respectively. The grooves 501 (a)-501 (d) of the first member 102(A) substantially align with grooves 507 (a)-507 (d) of the second member 102 (b), respectively, to form closed channels. Specifically, as an example, when the first member 102 (a) is positioned atop the second member 102 (b), the groove 501 (a) within the first member 102 (a) aligns with the groove 507 (a) within the second member 102 (b), to create one such channel. In this manner, the channels within the injector assembly 102 connect the inlet ports 105 (a)-105 (d) to the exit ports 107 (a)-107 (d), respectively, thus, directing the ink from the inlet ports to the exit ports.

A gasket material (not shown) is applied before the first member 102 (a) and the second member 102 (b) are aligned. The gasket material helps ensure a sealing connection between each groove pair, which prevents the ink from overflowing from one channel to another.

The ink delivery system of the present disclosure can be used in imaging devices, for delivering ink from different ink reservoirs to multiple print heads. The device may be a printing device, a scanning device, a photocopier, etc. Further, though explained in context of an imaging device, the ink delivery system may also find its applications in other environments, thus, not limiting of its implementation.

Although the current invention has been described comprehensively, in considerable details to cover the possible aspects and embodiments, those skilled in the art would recognize that other versions of the invention are also possible.

What is claimed is:

1. An ink delivery system for transporting ink to a plurality of print heads of an imaging device, the system comprising:
a rigid injector assembly including a first and a second member, each member being substantially T-shaped and having grooves, the grooves within the first member substantially aligning with the grooves within the second member, to create channels, the injector assembly being made of a conducting material; and
one or more pliable tubes, each having a first end connected to the injector assembly, and being in fluid communication with a channel within the injector assembly, and having a second end connected to a print head, the pliable tubes being composed of a flexible material, the second end of each pliable tube being freely movable with respect to the injector assembly.

2. The system of claim 1, wherein the two members of the rigid injector assembly are joined by positioning one member atop the other.

3. The system of claim 1, wherein the rigid injector assembly is substantially composed of aluminum.

4. The system of claim 1, wherein a heating assembly encompasses the injector assembly, the heating assembly being connected to a power supply, and being in thermal communication with the channels within the injector assembly.

5. The system of claim 4, wherein the heating assembly includes a first heating element attached to the first member of the injector assembly, and a second heating element attached to the second member of the injector assembly, the first and the second heating elements being fixedly connected to each other, to substantially encompass the injector assembly.

6. The system of claim 4, wherein the heating assembly is configured to maintain the ink flowing within the injector assembly, within a specific pre-determined temperature range.

7. The system of claim 4, wherein the heating assembly is insulated through an insulation layer substantially encompassing the heating assembly.

8. The system of claim 1, wherein the injector assembly has multiple inlet ports and exit ports, each exit port has an internal threaded portion, and each channel of the injector assembly connects an inlet port to an exit port.

9. The system of claim 8, wherein the upper end of each pliable tube has a threaded portion engaging with the threaded portion of an exit port of the injector assembly, to couple the pliable tubes with the injector assembly.

10. The system of claim 1, wherein the print heads connected to the lower ends of the pliable tubes, are configured to eject ink on a printing surface.

11. The system of claim 1, wherein the grooves within the rigid injector assembly are sealed to prevent overflow of ink therefrom.

12. The system of claim 1, wherein each pliable tube is surrounded by, and in thermal communication with a heating mechanism, the heating mechanism including a heating wire coiled around the pliable tube, the heating wire being connected to a power supply.

13. The system of claim 12, wherein the heating mechanism is configured to maintain the melted ink within a specified temperature range.

14. The system of claim 10, wherein each of the pliable tube is surrounded by a braided shielding, and is insulated.

15. The system of claim 1, wherein each pliable tube has a length above a pre-determined minimum value.

16. A method for transporting ink to a plurality of print heads of an imaging device, the method comprising:
positioning a first T-shaped member atop a second T-shaped member to form an injector assembly, the two members being composed of a conducting material;
providing multiple inlet ports and exit ports within the injector assembly;
providing grooves within the first member and the second member, the grooves being configured to substantially align to create channels for ink flow;
attaching a plurality of pliable tubes, one each to an exit port of the injector assembly;
receiving the ink through the inlet ports, guiding it through the channels, towards the exit ports, and receiving the ink into the pliable tubes; and
delivering the ink to the print heads through the pliable tubes.

17. A method of claim 16, wherein the conducting material is aluminium.

18. A method of claim 16, coupling a heating assembly to the injector assembly, connecting a power supply to the heating assembly, and facilitating thermal communication between the heating assembly and the injector assembly.

19. A method of claim 18, further comprising, attaching a first heating element to the first member, and attaching a second a heating element to the second member, to form the heating assembly.

20. A method of claim 16, wherein each pliable tube has an upper threaded portion, and each exit port has an inner threaded portion, the method further comprising, facilitating engagement of the upper threaded portion of each pliable tube with the inner threaded portion of one of the exit ports.

21. A method of claim 16, further comprising, sealing the channels within the injector assembly, to prevent overflow of ink therefrom.
